(19) United States
(12) Patent Application Publication
(10) Pub. No.: US 2014/0108211 A1
(43) Pub. Date: Apr. 17, 2014

(54) DEVICE, SYSTEM AND METHOD FOR ELECTRONIC ACCOUNTING

(71) Applicant: Konstantin Sergeevich BOGDANOV, Saint Petersburg (RU)

(72) Inventor: Konstantin Sergeevich BOGDANOV, Saint Petersburg (RU)

(21) Appl. No.: 14/033,532

(22) Filed: Sep. 23, 2013

Related U.S. Application Data
(63) Continuation-in-part of application No. PCT/RU2012/000046, filed on Jan. 31, 2012.

(30) Foreign Application Priority Data
Mar. 21, 2011 (RU) 2011110342

(51) Int. Cl. G06Q 40/00

(52) U.S. Cl. CPC G06Q 40/12
USPC 705/30

(57) ABSTRACT

The present invention relates to a computer-implemented method of electronic accounting upon entries based on at least one source accounting document representing at least one business transaction and a computer-implemented system for electronic accounting. The method and the system allowing improving accounting efficiency with a computer and providing control for financial position and/or economical activity of any businesses or individuals in any accounting unit in real-time scale and allowing a user to control for financial positions and economical activities of at least two businesses or individuals in real-time scale. Additionally, the present invention relates to a computer-implemented data processing system for generating a consolidated financial and/or management statements, the data processing system comprising, in particular, at least two computer-implemented systems used for the electronic accounting.

### CROSS-REFERENCE TO RELATED APPLICATIONS

This application is a continuation-in-part of International Application No. PCT/RU2012/000046 filed Jan. 31, 2012, published on Sep. 27, 2012 under publication number WO/2012/128663 A2, which claims priority benefit of Russian Patent Application No. 2011110342, filed on Mar. 21, 2011, the entire contents of which are incorporated herein by reference.

### BACKGROUND OF THE INVENTION

1. Field of the Invention

The present invention generally relates to devices, systems and methods for automated accounting in real-time scale. More particularly, the invention relates to computerized devices and computer-implemented methods for electronic accounting on the basis of source accounting documents of any businesses or individuals, and to systems for generating financial and/or management statements and/or consolidated financial and/or management statements on the basis of source accounting documents of two or more businesses or individuals, and also relates to devices and methods for filling a ledger accounts database in electronic accounting on the basis of source accounting documents of any businesses or individuals.

2. Description of the Related Art

Various accounting methods and accounting system devices based on the methods are known in the prior art.

In general, an accounting system provides a necessary link between source accounting documents and financial statements, aiming at giving the businesses the most comprehensive and adequate information about their trade. Thus, source accounting documents and accounting (financial) statements may be considered as an input and output of the accounting system, respectively (see http://www.buh.ru/docunnent-638, Y. V. Sokolov).

Various accounting systems have been created over the centuries to provide accounting specialists with effective tools enabling them to report to stakeholders on financial positions and/or economical activities of businesses, wherein said accounting systems being such as Venetian, new Italian, German, French, American, Russian, logismography, chessboard, integral accounting systems and others.

Generally, sequence of steps according to the Venetian accounting system can be presented as follows (see e.g. http://www.buh.ru/docunnent-463, Y. V. Sokolov):

1. Recording data on economic activities;
2. Recording the data of step 1 into a Memorandum;
3. Recording the data of step 2 into a Journal;
4. Recording the data of step 3 into a Ledger book;
5. Creating a Trial balance on the basis of the data of step 4;

### 6. Preparation of Financial Statements.

For example, U.S. Pat. No. 6,275,813 describes a computerized system based on a double-entry accounting principle of the above mentioned Venetian accounting system. An accounting system device comprising the Memorandum and the Journal is implemented on the basis of the above mentioned accounting steps. The Memorandum represents data of source accounting documents in chronological order. The Journal operates as a ledger accounts database, said Journal being filled with data of the Memorandum and comprising ledger account tables filled in the double-entry manner, the double-entry principle being used today in all accounting system devices in the prior art. According to the Journal, each business transaction is recorded twice into the ledger accounts database in common accounting (reference) currency units, therefore the data on economic activities based on source accounting documents are evaluated (converted to the common accounting (reference) currency) prior to the data are recorded into the Journal using relative value data obtained from various data sources, the relative value data being such as currency exchange rates of the Central Bank where the currency exchange rates are a relative accounting unit values database.

In this accounting system device and other accounting system devices known in the prior art, the relative accounting unit values database is an external database communicating with an input of the accounting system devices. When filling out the Ledger and preparing the Trial balance and other statements containing a statement of financial position and a statement of comprehensive income of businesses or individuals, a statements generator function is realized, i.e. the device representing the Venetian accounting system comprises the statements generator connected with the ledger accounts database.

Thus, the Venetian accounting system device comprises a Memorandum, a ledger accounts database connected with the Memorandum, and a statements generator communicating with the ledger accounts database. An input of the Venetian accounting system device is configured to communicate with an external relative accounting unit values database (conversion process of accounting units to a common accounting currency). The ledger accounts database comprises ledger account tables filled in the double-entry manner with data of source accounting documents, the data being in a common (reference) accounting currency. Economic activity facts generally represented in the source accounting documents are the input of the Venetian accounting system device, and statements are an output of said device.

Disadvantages of the Venetian accounting system device are as follows:

1. The Venetian accounting system device may not be used for modern effective accounting of all business transactions relating to a businesses or individuals, because ledger accounts database and statements obtained in the output of said device contain data in a common accounting (reference) currency.

Therefore, when a relative value of any accounting unit, e.g. currency exchange rates or stock values, is changed, there is a need to register additional business transactions as rate corrections and valuation adjustments, and therefore, in order to have statements in a currency being different from the accounting (reference) currency or in another accounting unit, it is necessary to remove all rate corrections and valuation adjustments from the ledger accounts database and to enter thereinto new rate corrections and new valuation adjustments with respect to the currency or to the another accounting unit over a whole accounting period. It is due to the fact that the relative accounting unit values database communicates only with the input of the Venetian accounting system device, and data of source accounting documents are recorded into the ledger account tables as already valuated data, and, therefore, the data are to be reevaluated and re-recorded when the relative value is changed.

2. The Venetian accounting system device does not allow a user to obtain correct data on a financial position and economical activity of businesses or individuals in real-time scale. Due to the fact that the relative accounting unit values database communicates only with the input of the Venetian accounting system device, and whenever data of said database, e.g. currency exchange rates or stock values, are changed, in order to correctly represent a financial position and economical activity of businesses or individuals, it is necessary to enter every time further rate corrections and valuation adjustments via registration additional business transactions along with recording corresponding data into the ledger account tables of the ledger accounts database in the double-entry manner. Taking into account frequent changes of the relative value of the accounting units in practice, e.g. continuous changes of stock values, above described actions are difficult and extremely time-taking. Thus, statement data obtained in real-time scale may be not actual. Furthermore, even when the Venetian accounting system device is used with a computer, most operations are to be performed manually. On the other hand, non-computer based accounting makes difficult a generation of statements of financial position and operating results of any businesses or individuals, that is caused by large number of ledger account tables forming ledger accounts database.

Furthermore, there has been known the new Italian accounting system (see FIG. 1 and http://www.buh.ru/document.jsp?ID=478, Y. V. Sokolov). FIG. 1 represents a new Italian accounting system device and illustrates Source accounting documents 0 connected with a Memorandum 1 communicating with a Journal 4 and Analytical accounting registers 2. The Journal 4 is connected with a Ledger 5 whereof a Trial balance 6 for accounts control is formed, and the Analytical accounting registers 2 form a Trial balance 3 for analytical accounts, the Trial balance 3 communicating with the Ledger 5 and with the Trial balance 6 for control accounts, whereof statement 7 of financial position and statement 8 of comprehensive income.

As illustrated in FIG. 1 representing the new Italian accounting system device, a ledger accounts database is divided into two parts: the Journal 4 and the Analytical accounting registers 2. Thus, a management statement and a financial (accounting) statement are separated from each other. It allows the optimizing the obtaining of summary data on a financial position and economical activity of businesses or individuals, as illustrated in FIG. 1 as statement 7 of financial position and statement 8 of comprehensive income. Such optimization is evident only in paper-based accounting, e.g. when a computer is not used. The Journal 4 and the Analytical accounting registers 2 comprise ledger account tables, therefore they operate as the ledger accounts database, and said ledger account tables of the ledger accounts database are filled with data converted to a common accounting (reference) currency in the double-entry manner. The Ledger 5, the Trial balance 3 for analytical accounts, the Trial balance 6 for control accounts, and the statement 7 of financial position and the statement 8 of comprehensive income are formed using data of the ledger accounts database and generated by a statements generator, i.e. the new Italian accounting system device comprises the statements generator connected with the ledger accounts database.

As a result, the new Italian accounting system device comprises the memorandum connected with the ledger accounts database communicating with the statements generator, and the relative accounting unit values database communicating (conversion process of accounting units to a common accounting (reference) currency) with an input of the new Italian accounting system device, wherein said ledger accounts database comprises ledger account tables filled with data in the double-entry manner in the common accounting (reference) currency. Statements are an output of the new Italian accounting system device.

In general, the new Italian accounting system device allows the overcoming one of disadvantages of the Venetian accounting system device, namely it optimizes the generating consolidated statements of financial position and operating results of businesses or individuals by separation of the analytical ledger account registers, but said optimization is achieved when non-computer-based accounting is used.

However, the new Italian accounting system device has the following essential disadvantages:

1. As described above for the Venetian accounting system device, the new Italian accounting system device also may not be used for effective accounting of all business transactions relating to a businesses or individuals
2. As described above for the Venetian accounting system device, the new Italian accounting system device also does not allow a user to obtain correct data on a financial position and economical activity of businesses or individuals in real-time scale.
3. The new Italian accounting system device requires a lot of manual work, even when said device uses a computer.

Both in the Venetian accounting system device and the new Italian accounting system device, data of source accounting documents are recorded into the ledger account tables of the ledger accounts database in double-entry manner, i.e. each business transaction is recorded twice into the corresponding ledger account tables: once as a positive value (to the account debit) and once as a negative value (to the account credit), wherein said data are recorded in values converted to a common accounting (reference) currency. Consequently, evaluation (conversion to a common accounting (reference) currency) of economic activity facts based on source accounting documents is carried out before said economic activity facts are recorded into the ledger accounts database.

The double-entry method generally used for recording data into the ledger accounts database has a significant disadvantage, namely, said double-entry method does not allow the recording data into the ledger accounts database in natural accounting units without violation of the main principle of the double-entry method, namely all debit amounts are equal to all credit amounts, i.e. sum of all ledger account values is equal to zero. Therefore, the recording data is to be carried out in a common accounting (reference) currency. However, use of the common accounting (reference) currency does not allow a user to promptly take into account valuation adjustments, changes of currency exchange rates or relative values of any other accounting units without further records in the ledger account tables of the ledger accounts database, said ledger account tables that would store said changes, and it is virtually impossible to provide entering said records upon each change in relative values. Therefore, the double-entry method or a device based on said method does not allow the user to control for financial position and economical activity in real-time scale. Furthermore, statements of financial position and operating results may be obtained only in an accounting (reference) currency, because complete re-recording of all additional rate corrections and valuation adjustments is required in order to change the accounting (reference) currency. Moreover, today there is no system of above-mentioned accounting system devices in the prior art, said system allowing a user to effectively account all business transactions relating to a plurality of businesses or individuals and to promptly obtain consolidated financial and/or management statements in real-time scale, said statements representing current data on a financial position and economical activity of a plurality of any businesses or individuals.

As a result, there is a need for developments in the field of accounting system devices and accounting methods used therein.

### SUMMARY OF THE INVENTION

An object of the present invention is to provide an improved accounting system and an improved accounting method, the method and the system based on said method allowing improving accounting efficiency with a computer and providing control for financial position and/or economical activity of any businesses or individuals in any accounting unit in real-time scale.

A still another object of the invention is to provide a system comprising the improved accounting system devices, said system allowing a user to control for financial positions and economical activities of at least two businesses or individuals in real-time scale.

To achieve the object of the invention, as embodied and broadly described herein, there is provided a computer-implemented system for electronic accounting, comprising: an external electronic apparatus (9) comprising a data storage device for storing ledger account data representing entries based on at least one accounting document for the electronic accounting, and a transmitter for transmitting the ledger account data; a computer-implemented device (0) for the electronic accounting, comprising: a receiver for receiving the transmitted ledger account data; a first processor (3) configured to perform the electronic accounting; a first data storage (1) containing at least one basic storage element of the first data storage for storing data of main ledger accounts, and an additional storage element of the first data storage for storing data of an additional ledger account; a data entry unit connected to the receiver and to the first data storage and configured to simultaneously enter four entries of the ledger account data in a cross-entry manner, such that first data are entered into one basic storage element of the first data storage, wherein the first data are based on the received ledger account data, second data are entered into the additional storage element of the first data storage for balancing the entered first data, third data are entered into one basic storage element of the first data storage, wherein the third data are based on the received ledger account data, fourth data are entered into the additional storage element of the first data storage for balancing the entered third data; a second data storage (2) for storing relative values of accounting units for the data of main ledger accounts, the relative values representing a correlation between at least two of the accounting units; wherein the first processor (3) is configured to automatically generate management and/or financial statements and connected with the first data storage (1) to obtain the data of main ledger accounts and with the second data storage (2) to obtain the relative values, the first processor (3) further converting the data of main ledger accounts into data subject to inclusion to the management and/or financial statements on the basis of the obtained relative values, and provided a computer-implemented method of electronic accounting, the computer-implemented method comprising the steps of: receiving, by a receiver, ledger account data from an external electronic apparatus, wherein the ledger account data represent entries based on at least one accounting document for the electronic accounting; entering first data into one basic storage element of at least one basic storage element of a first data storage using a data entry unit, wherein the first data are based on the received ledger account data; entering second data into an additional storage element of the first data storage using the data entry unit to balance the entered first data; entering third data into one basic storage element of the at least one basic storage element of the first data storage using the data entry unit, wherein the third data are based on the received ledger account data; entering fourth data into the additional storage element of the first data storage using the data entry unit to balance the entered third data; entering relative values of the accounting units for the data of main ledger accounts into a second data storage using the data entry unit, the relative values representing a correlation between at least two of the accounting units; transmitting the data of main ledger accounts from the first data storage to a first processor connected with the first data storage; transmitting the relative values from the second data storage to the first processor connected with the second data storage; converting the obtained data of main ledger accounts into data subject to inclusion to the management and/or financial statements on the basis of the obtained relative values using the first processor; and generating a management and/or financial statements in at least one of the accounting units on the basis of the converted data using the first processor.

The computer-implemented system or computer-implemented method of electronic accounting allows a user to reduce excessive computer resources usage, in particular the usage of processor or microcontroller resources, RAM and ROM resources and other computer resources, because the ledger account data of the first data storage are not to be reevaluated and re-recorded such that to generate management and/or financial statements in cases when the relative values of the accounting units are changed or when the accounting unit is changed. Furthermore, the reduced utilization of computer resources, in particular reduced number of writing/reading/revaluating operations, results in extended life cycle of the computer elements and increased rate of accounting operations when generating financial and/or management statements.

Moreover, the computer-implemented system or computer-implemented method allows preventing situation when computer elements operate at full capacity that may course data losses and/or system failures because of overheating and/or failures of the elements, and/or course time delays when generating financial and/or management statements due to increased number of operations to be performed by a processor or microcontroller.

To achieve the still another object of the invention, as embodied and broadly described herein, there is provided a computer-implemented processing system for generating a consolidated financial and/or management statements, the data processing system comprising: a second processor (18) configured to form the consolidated financial and/or management statements; at least two computer-implemented systems (0) of claim 1, one for each business or individual, for generating a financial and/or management statements of the each business or individual; a third data storage (17) for storing relative values of accounting units for data of main ledger accounts, the relative values representing a correlation between at least two of the accounting units; wherein the second processor (18) is further configured to generate a consolidated financial and/or management statements and connected with the first data storages (1) of the at least two computer-implemented systems (0) such that to obtain the data of main ledger accounts therefrom and connected with the third data storage (17) such that to obtain the relative values therefrom, the second processor (18) further converting the obtained data of main ledger accounts into data subject to inclusion to the consolidated management and/or financial statements on the basis of the obtained relative values.

The data processing system allows a user to significantly reduce time and money spent for preparation of the consolidated management and/or financial statements of the two or more businesses or individuals and to obtain said consolidated statements in any required accounting unit in the real-time scale. Furthermore, the data processing system further allows the significant reducing usage of processor or microcontroller resources, RAM and ROM resources, and other computer resources due to using the improved programmable devices designed to save the computer resources.

Additional features and advantages of the invention will be set forth in part in the description which follows and in part will be obvious from the description, or may be learned by practice of the invention. The above objectives and other advantages of the invention are realized and attained by the above methods, devices and system particularly pointed out in the description and claims hereof as well as the appended drawings.

Moreover, it is to be understood that both the foregoing general description and the following detailed description are exemplary and explanatory only and are not restrictive of the invention, as described. Further features and/or variations may be provided in addition to those set forth herein. For example, the present invention may be directed to various combinations and subcombinations of the disclosed features and/or combinations and subcombinations of several further features disclosed below in the detailed description.

### BRIEF DESCRIPTION OF DRAWINGS

The accompanying drawings, which are incorporated in and constitute a part of the description, illustrate various embodiments and aspects of the present invention and, together with the description, explain the principles of the invention. In the drawings:

FIG. 1 is a diagram illustrating a new Italian accounting system.

FIG. 2 illustrates a programmable device for electronic accounting.

FIG. 3 is a block diagram of one embodiment of the programmable device of FIG. 2 for electronic accounting constructed in accordance with, and embodying, the principles of the present invention;

FIG. 4 is a block diagram of another embodiment of the programmable device of FIG. 2 for electronic accounting constructed in accordance with, and embodying, the principles of the present invention;

FIG. 5 is a block diagram of still another embodiment of the programmable device of FIG. 2 for electronic accounting constructed in accordance with, and embodying, the principles of the present invention;

FIG. 6 is a block diagram of yet still another embodiment of the programmable device of FIG. 2 for electronic accounting constructed in accordance with, and embodying, the principles of the present invention;

FIG. 7 is a system for generating consolidated financial and/or management statements.

FIG. 8 shows one embodiment of the system illustrated in FIG. 7 for generating consolidated financial and/or management statements.

FIG. 9 shows another embodiment of the system illustrated in FIG. 8 for generating consolidated financial and/or management statements.

FIG. 10 illustrates a filling device for filling a database comprising ledger accounts.

FIG. 11 illustrates a basic ledger account “Money” table.

FIG. 12 illustrates a basic ledger account “Valuation adjustment” table.

FIG. 13 illustrates a basic ledger account “Debt” table.

FIG. 14 illustrates the changed ledger account “Valuation adjustment” table of FIG. 12.

FIG. 15 is Relative values table of the second data storage.

FIG. 16 is an explanatory statement of financial position.

FIG. 17 shows changed relative values table of FIG. 15.

FIG. 18 shows changed statement of financial position of FIG. 16.

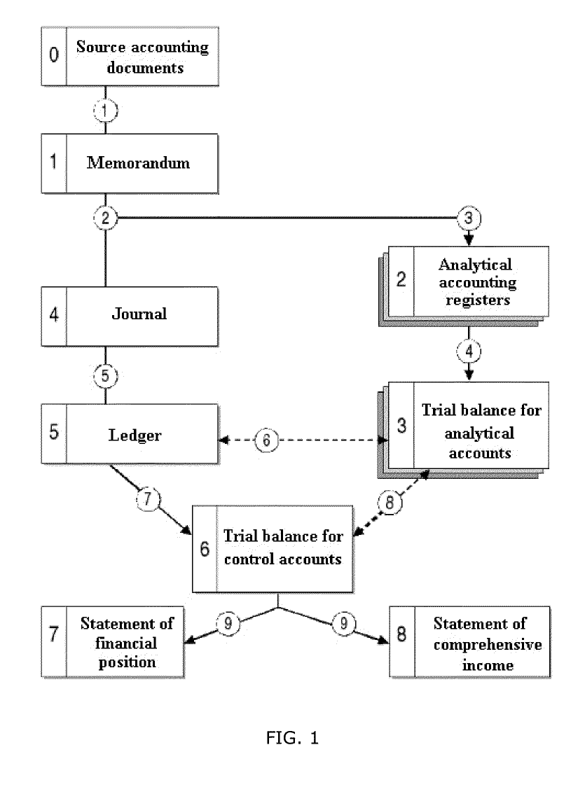

### DESCRIPTION OF THE PREFERRED EMBODIMENTS

Reference will now be made in detail to the invention, examples of which are illustrated in the accompanying drawings. Wherever possible, the same reference numbers will be used throughout the drawings to refer to the same or like parts.

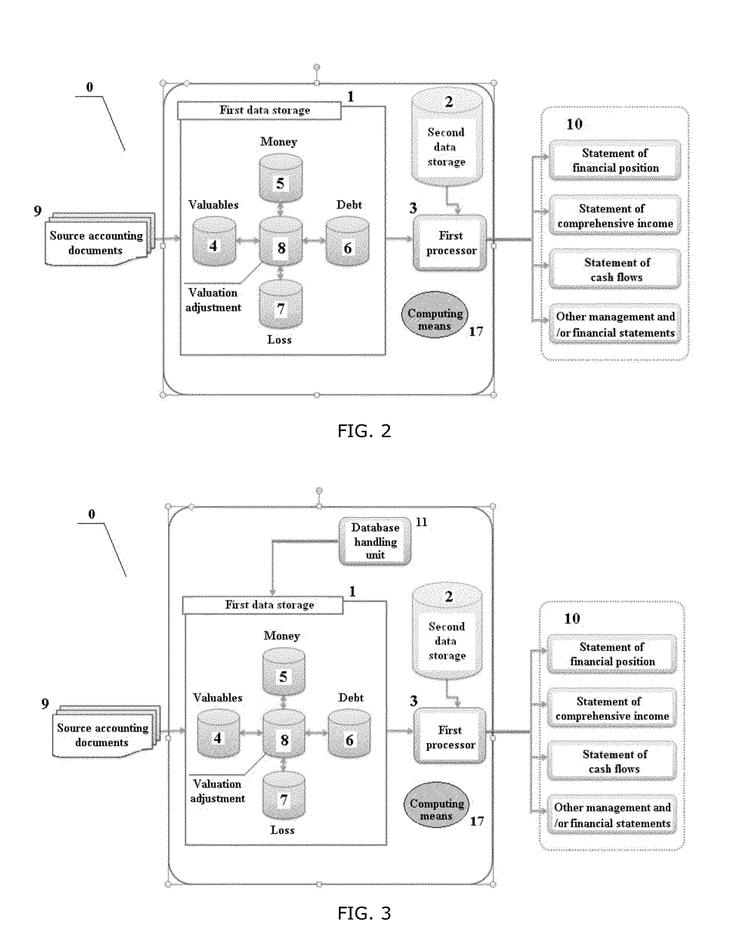

FIG. 2 shows a computer-implemented device 0 for an electronic accounting, the device 0 comprising computing unit 17, a first data storage 1, a second data storage 2 and first processor 3. The device 0 is configured to obtain entries from at least one source accounting document 9 for the electronic accounting, said at least one accounting document representing at least one business transaction recorded therein. The at least one source accounting document 9 may be an electronic accounting document stored in a data storage device of an external computer or data server, wherein the device 0 is connected with such external computer or data server such that to obtain ledger account data based on the electronic accounting document therefrom via a communication network such as LAN, Wi-Fi, 3G or 4G and etc. Furthermore, the at least one source accounting document 9 may be a paper accounting document, wherein the device 0 in this case may comprise or be connected with a data input unit, such as keyboard, mouse and etc., configured to enter by a user the ledger account data corresponding to the at least one paper accounting document into the first data storage 1 of the device 0. In one another embodiment of the present invention, when the at least one source accounting document 9 is a paper accounting document, the device 0 may comprise a scanning unit, such as a scanner, camera for capturing information on the at least one paper accounting document or other commercially available scanning device, configured to scan the at least one paper accounting document and recognize the scanned accounting documents such that to obtain desired ledger account data therefrom.

Additionally, in one embodiment of the present invention in order to obtain the entries the device 0 may be connected with an external database, local or remote server, or at least one external electronic apparatus, said means comprising data representing the at least one business transaction and being connected with the device 0 in a wire and/or wireless manner with specific receivers integrated into the device 0, such as LAN receiver (network interface card or network adapter), Bluetooth, Wi-Fi, IR-, WiMAX, 3G or 4G receiver, other commercially available receivers or any combination thereof, and with corresponding specific transmitters integrated into the means such that to transmit desired data to the device 0.

The computing unit 17 of the device 0 are configured to perform the electronic accounting. The computing unit 17 may be in the form of commercially available central processor unit (CPU), said central processor having at least one core, at least one general purpose processor, at least one microcontroller provided with at least one programmer to upload desired software such that to perform the electronic accounting, separate custom chip, an application specific integrated circuit (ASIC) or another analog circuit specialized for digital data processing, or any combination thereof designed to perform the electronic accounting. Furthermore, the computing unit 17 may be the first processor 3.

The first data storage 1 of the device 0 is configured to store ledger accounts containing ledger account data representing corresponding entries based on the at least one source accounting document 9 representing at least one business transaction. The corresponding entries are recorded in the ledger accounts of the first data storage 1 in natural accounting units in real-time scale, wherein said ledger accounts are balanced. It provides correspondence of recording the ledger account data into the first data storage 1 to the double-entry principle know in the prior art.

The second data storage 2 of the device 0 is entirely separated from the first data storage 1 and configured to store relative values of the accounting units, the relative values representing a correlation between at least two of the natural accounting units and being updated in real-time scale.

The first data storage 1 and/or second data storage 2 of the device 0 may be in the form of commercially available data medium of any type. For example, in various embodiments the first data storage 1 and/or second data storage 2 of the device 0 may be in the form of at least one of hard-drive disk (HDD) or RAID drive, solid-state drive (SSD), magnetic disc, spinning drive, optical disc, or at least one memory card of any types, such as SD card, MMC card, SmartMedia card, Memory stick, Compact Flash card, PC card of I, II and III types and CardBus type, Miniature card, xD Picture card, MirrorBit Flash card and other types of memory cards, or in the form of any combination thereof, or may use others memory technologies that may be known or developed in the prior art. Thus, in the various embodiments of the present invention the device 0 may comprise specific readers integrated into the device 0, the specific readers are configured to read data recorded into one of the above mentioned data mediums and to write desired data thereinto as well, and/or may comprise at least one corresponding slot being configured to receive at least one of above mentioned data mediums.

Furthermore, in some other embodiments of the invention the first data storage 1 and second data storage 2 of the device 0 may be in the form of two database elements of a database or in the form of two separated databases, the one database or the two databases being stored in at least one of the above mentioned data mediums.

In another embodiment of the present invention an external electronic apparatus may be used in addition to the at least one source accounting document 9. In particular, the external electronic apparatus may be an external server or external computer. In this embodiment the external electronic apparatus is configured to receive ledger account data representing entries based on the at least one source accounting document representing at least one business transaction. According to this embodiment, in case when the at least one source accounting document 9 are stored in electronic form in at least one external database, external computer or external data server, the external electronic apparatus may be connected with the at least one external database, external computer or external data server such that to obtain ledger account data based on the at least one source accounting document therefrom via a communication network such as LAN, Wi-Fi, 3G or 4G and etc. The external electronic apparatus further comprises a data storage device for storing the received ledger account data, and a transmitter for transmitting the stored ledger account data. According to still another embodiment of the present invention, in case when the at least one source accounting document 9 is paper accounting document, the external electronic apparatus may comprise or be connected with a data input unit, such as keyboard, mouse and etc., configured to enter by a user the ledger account data corresponding to the at least one paper accounting document into the data storage device of the external electronic apparatus. Furthermore, according to one other embodiment, in case when the at least one source accounting document 9 is a paper accounting document, the external electronic apparatus may comprise or be connected with a scanning unit, such as a scanner, camera for capturing information on the at least one paper accounting document or other commercially available scanning device, configured to scan the at least one paper accounting document and to recognize the scanned accounting documents such that to obtain desired ledger account data therefrom. Further, the device 0 may be connected with the external electronic apparatus by means of a communication network, such as LAN, Wi-Fi, 3G or 4G and etc., comprising a data transfer unit for transferring the transmitted ledger account data from the external electronic apparatus to the device 0, wherein the transferred ledger account data may be received in the device 0 by means of the receiver of the device 0. The data transfer unit of the communication network may be a modem, router or other network device. The transmitter of the external electronic apparatus may be implemented in the form of hardware such as LAN transmitter, Bluetooth transmitter, Wi-Fi transmitter, IR-transmitter, WiMAX transmitter, 3G or 4G transmitter, or other commercially available transmitter integrated into the external electronic apparatus.

In the present invention the first data storage 1 and the second data storage 2 of the device 0 are in the form single database registered in the Russian register on 11 Jan. 2011 as “Cross-entry accounting system” (the number of the database certificate is 2011620012), the “Cross-entry accounting system” database are configured to be stored in one of above mentioned data mediums.

The first processor 3 of the device 0 is connected with the first data storage 1 such that to obtain the ledger account data and with the second data storage 2 such that to obtain the relative values data. Additionally, the first processor 3 of the device 0 is further configured to automatically generate a management and/or financial statement 10 in at least one of the accounting units with its current relative value and/or in at least one of the natural accounting units.

Furthermore, the first processor 3 of the device 0 is configured to generate in real-time scale any management and/or financial statements 10 in response to user's local or removal request, the user having correspondingly local and/or remote access to the device 0 and being authorized to use the device 0. In particular, said management and/or financial statements 10 are a statement of cash flows and/or a statement of financial position, and/or a statement of comprehensive income, and/or statement of changes in equity, and/or consolidated financial statements, and/or other financial and/or management statements known in the field of accounting. Thus, any above mentioned financial and/or management statements 10 may be generated automatically and/or manually. In addition, the first processor 3 of the device 0 is configured to further generate any types of diagrams and/or data tables on the basis of the information obtained from the first data storage 1 and/or from the second data storage 2 of the device 0 in response to user's certain request.

Particularly, the first processor 3 of the device 0 may be connected with the first data storages 1 of at least two devices 0 such that to obtain ledger account data therefrom and with at least one of second data storages 2 of the at least two devices 0 such that to obtain relative value data therefrom. Thus, the first processor 3 may be further configured to automatically generate consolidated management and/or financial statements in at least one of the accounting units with its current relative value and/or in at least one of the natural accounting units.

The first processor 3 may be in the form of additional hardware, such as processor, microcontroller designed to process data, an ASIC or another circuit specialized for digital data processing, integrated into the device 0 and/or in the form of software stored in the device 0 either together with first data storage 1 and/or second data storage 2 or separately therefrom into an additional data medium of any type described herein.

In the present invention the first processor 3 is a software registered in the Russian software register on 25 Nov. 2010 as “TMAPlatform” (the number of the software certificate is 2010617827), the “TMAPlatform” software allowing a user to automatically process data obtained in the real-time scale from the first data storage 1 and the second data storage 2 such that to generate any type of management and/or financial statements 10. Additionally, the “TMAPlatform” software further allows the user to automatically control data streams comprising transferred ledger account data and/or relative value data. Furthermore, the “TMAPlatform” software also is an integrated development environment enabling the user to develop additional processor. The additional processor may be implemented as at least one program module with any programming language supported by the “TMAPlatform” software, the at least one program module running on the computing unit 17, or as other further computing unit, such as processor, microcontroller designed to process desired data, separate custom chip, ASIC and etc. as described herein, integrated into the device 0. Moreover, the “TMAPlatform” software running on the computing unit 17 of the device 0 enables the user to upgrade the first processor 3 such that to extend the functionality thereof. As a result, according to the above functionality of the first processor 3, the device 0 is programmable device.

In addition, the first processor 3 of the device 0 may be implemented in the form of at least two program modules running on the computing unit 17 of the device 0, the at least two program modules being implemented with the “TMAPlatform” software or with at least one standard programming language supported by an integrated programming environmental used in the device 0 and being configured to communicate with each other to provide processing information obtained from the first data storage 1 and/or from the second data storage 2 of the device 0.

The ledger account data of the ledger accounts stored in the first data storage 1 of the device 0 are recorded in at least one ledger accounts table. Moreover, the ledger accounts stored in the first data storage 1 of the device 0 are at least one basic ledger account covering all data on financial position, economical activities, profits and losses and the additional ledger account “Valuation adjustment” 8 intended to cross-enter therethrough the ledger account data into the at least one basic ledger account in the natural accounting units. Also the ledger account data of the at least one basic ledger account and additional ledger account “Valuation adjustment” 8 stored in the first data storage 1 of the device 0 are recorded in at least one basic ledger accounts table of the at least one basic ledger account and in at least one ledger account “Valuation adjustment” table of the additional ledger account “Valuation adjustment” 8, respectively, wherein each of said at least one basic ledger accounts table and each of said at least one ledger account “Valuation adjustment” table comprises at least one row and at least one column forming at least one table cell for recording the ledger account data thereinto.

FIG. 3 shows another embodiment of the device 0 of FIG. 2. Referring to FIG. 3 the device 0 further comprises a database handling unit 11 connected with the first data storage 1 of the device 0 such that to obtain required data therefrom and to modify it. The database handling unit 11 is configured to consolidate the at least one basic ledger accounts table and the at least one ledger account “Valuation adjustment” table with each other in any combination to obtain at least one resultant table.

The database handling unit 11 of the device 0 is further configured to add at least one additional column and/or at least one additional row to the at least one basic ledger accounts table and/or to the at least one ledger account “Valuation adjustment” table, and to delete at least one column and/or at least one row from the at least one basic ledger accounts table and/or from the at least one ledger account “Valuation adjustment” table to obtain at least one modified basic ledger accounts table and/or at least one modified ledger account “Valuation adjustment” table.

Additionally, the database handling unit 11 of the device 0 is implemented as another program module developed with the “TMAPlatform” software, the “TMAPlatform” software being an integrated development environment enabling the user to develop additional program modules. Moreover, the database handling unit 11 of the device 0 of the present invention is a part of the “TMAPlatform” software running on the computing unit 17 of the device 0. Additionally, the database handling unit may be implemented both with any commercially or freely available programming language designed for managing and processing data in databases, in particular in relational database management systems, and with corresponding integrated development environmental intended for the programming language. For example, such programming languages and query languages as MySQL, Oracle, PostgreSQL, Microsoft Access, Paradox, dBase, FoxPro, .QL, 4D QL, Datalog, IBM BS12, ISBL, JPQL, LINQ, QBE, SBQL, UnQL, SQLite, CouchDB, XQuery or etc. may be used to develop any desired database handling unit.

In addition, the database handling unit 11 of the device 0 may be implemented in the form of at least two program modules running on the computing unit 17 of the device 0, the at least two program modules being implemented with “TMAPlatform” software or with at least one programming language mentioned above and being configured to communicate with each other to provide the consolidating and/or deleting the at least one table of the first data storage 1 of the device 0. Furthermore, the “TMAPlatform” software further allows the user to automatically control data streams comprising data relating to the modifying of the at least one table of the first data storage 1 of the device 0.

Furthermore, the database handling unit 11 of the device 0 also may be in the form of any commercially available additional processor, microcontroller designed to process databases or ASIC specialized for databases processing, said processor, microcontroller or ASIC being configured to be integrated into the device 0, respectively.

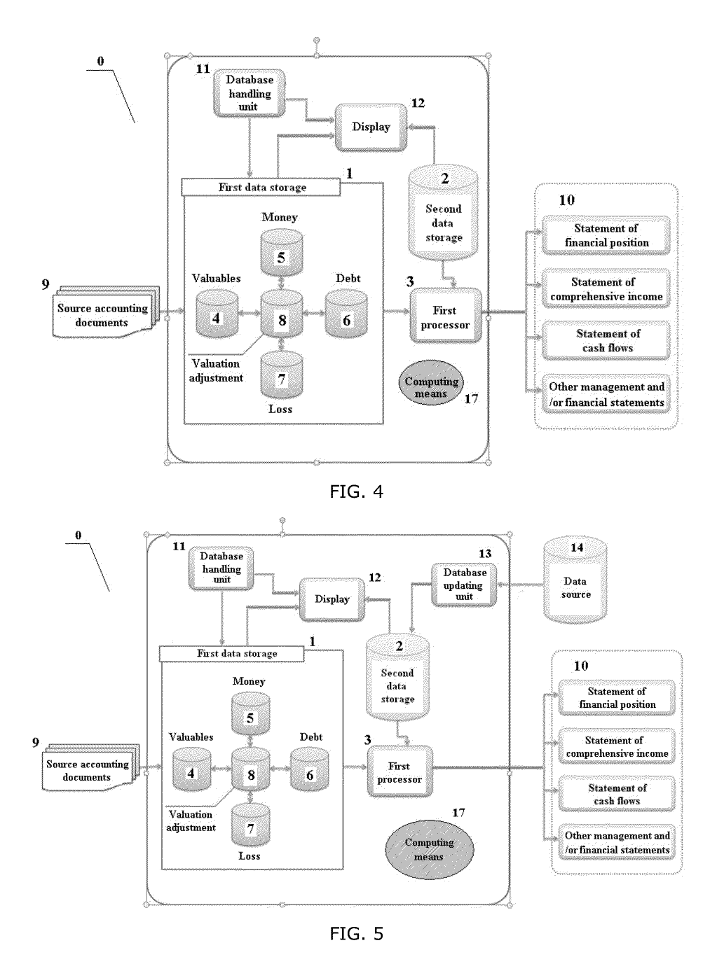

FIG. 4 shows still another embodiment of the device 0 of FIG. 2. Referring to FIG. 4 the device 0 further comprises display 12 integrated into the device 0 and connected with the first data storage 1, second data storage 2 and database handling unit 11 as shown in FIG. 3. The display 12 of the device 0 is configured to display the at least one basic ledger accounts table and/or the at least one ledger account “Valuation adjustment” table, and/or the at least one resultant table, and/or the at least one modified basic ledger accounts table and/or the at least one modified ledger account “Valuation adjustment” table.

In particular, the display 12 of the device 0 is further configured to display any data stored in the first data storage 1 and/or second data storage 2 in any desired graphical and/or table forms. The display 12 may display desired information automatically and/or in response to user's request. The display 12 of the device 0 may be in the form of LED, ELD, Electronic paper E Ink, PDP, LCD, HPA, TFT, OLED, SED, IMOD, laser display and other underlying and three dimensional display technologies. Furthermore, device 0 as illustrated in FIG. 4 may comprise at least two displays 12, and also an external display having one of the display types mentioned above may be used as the display 12 of the device 0. In addition, the display 12 is also configured to display any further information required for the user.

FIG. 5 shows another embodiment of the device 0 as illustrated in FIG. 4. In the illustrated embodiment the device 0 further comprises a database updating unit 13 connected with an external data source 14 in a wire and/or wireless manner such that to obtain data on at least one of the natural accounting units and connected with the second data storage 2 of the device 0 such that to update the relative values stored therein. Thus, the database updating unit 13 are configured to automatically update the relative values stored in the second data storage 2 in real-time scale.

The data source 14 connected with the database updating unit 13 of the device 0 is an external database, computer, server, website, satellite or at least one another external electronic device, wherein the external database may be stored in any data medium as described herein.

Additionally, the database updating unit 13 of the device 0 is implemented as still another program module developed with the “TMAPlatform” software running on the computing unit 17 of the device 0, the “TMAPlatform” software being an integrated development environment enabling the user to develop additional program modules. Thus, the database updating unit 13 of the device 0 of the present invention are a part of the “TMAPlatform” software stored in the device 0. Furthermore, the “TMAPlatform” software further allows the user to automatically control data streams comprising data on the at least one of the natural accounting units such that to update the relative values stored in the second data storage 2 of the device 0.

The database updating unit 13 may be embodied in various forms such as the first processor 3, an additional processor, a microcontroller designed to process data, an ASIC specialized for digital data processing or any other specialized additional hardware which is integrated into the device 0.

In addition, the database updating unit 13 of the device 0 may be implemented in the form of at least two program modules running on the computing unit 17 of the device 0, the at least two program modules being implemented with the “TMAPlatform” software or with at least one standard programming language supported by an integrated programming environmental used in the device 0 and being configured to communicate with each other to provide updating the relative values of the second data storage 2 of the device 0.

Furthermore, the database updating unit 13 of the device 0 may be connected with at least two data source 14 such that to ensure timely and uninterrupted updating the relative values of the second data storage 2 of the device 0 in real-time scale.

In another aspect of the device 0 of FIG. 5, the data source 14 may be an external server or an external computer and be configured to receive data on at least one of the natural accounting units. In this aspect the database updating unit 13 is connected with the external server or external computer via a communication network, such as LAN, Wi-Fi, 3G or 4G and etc, comprising a data transfer unit for transferring the received data on the least one of the natural accounting units from the external server or external computer to the device 0, wherein the transferred data may be received in the device 0 by means of the receiver of the device 0, the receiver being connected with the database updating unit 13. Additionally, the computer-implemented device 0 connected with the external server or external computer configured to receive data on at least one of the natural accounting units via the communication network may form a computer-implemented system for electronic accounting. The data transfer unit of the communication network may be a modem, router or other network device.

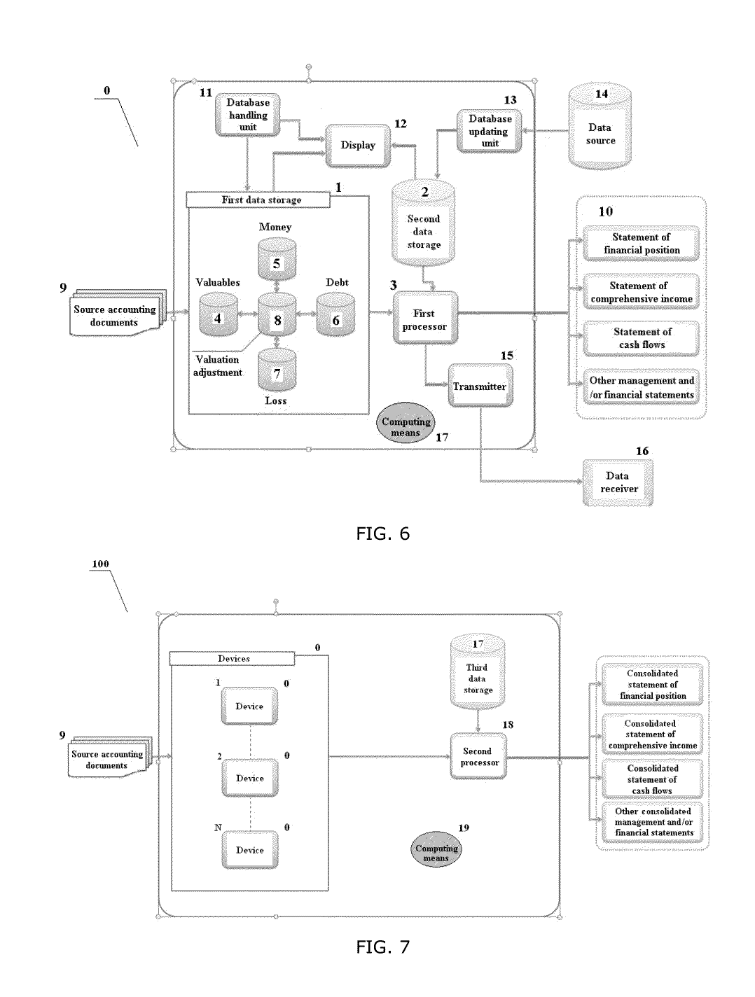

FIG. 6 shows yet another embodiment of the device 0 as illustrated in FIG. 5. In the illustrated embodiment the device 0 further comprises transmitter 15 connected with the first processor 3 such that to obtain the required data therefrom and connected with a remote computer and/or server, and/or other electronic devices in the wire and/or wireless manner such that to transmit the required data thereto. Thus, the transmitter 15 is configured to transmit required data of the management and/or financial statements 10 in a wire and/or wireless manner to remote computer and/or server, and/or other electronic devices in response to user's request and/or automatically. The transmitter 15 of the device 0 allows a user, manager, business owner, stakeholders or any other persons authorized to have such information to manually and/or automatically obtain desired information about his business in response to the request in real-time scale.

The transmitter 15 of the device 0 is implemented as yet another program module developed with the “TMAPlatform” software running on the computing unit 17 of the device 0, the “TMAPlatform” software being an integrated development environment enabling the user to develop additional program modules. Thus, the database updating unit 13 of the device 0 of the present invention is a part of the “TMAPlatform” software stored in the device 0. Furthermore, the “TMAPlatform” software further allows the user to automatically control data streams comprising data transmitted between the transmitter and an external data receiver 16.

The transmitter 15 may be implemented in the form of additional hardware such as LAN transmitter, Bluetooth transmitter, Wi-Fi transmitter, IR-transmitter, WiMAX transmitter, 3G or 4G transmitter, other commercially available transmitters integrated into the device 0 or any combination thereof.

Additionally, transmitter 15 of the device 0 may be implemented in the form of at least two program modules running on the computing unit 17 of the device 0, the at least two program modules being implemented with the “TMAPlatform” software or with at least one standard programming language supported by an integrated programming environmental used in the device 0 and being configured to communicate with each other to provide updating the relative values of the second data storage 2 of the device 0.

The external receiver 16 is implemented in the form corresponding to the type of the transmitter 15 or in another form designed to receive data from the transmitter 15 of the device 0.

In order to implement the wire and/or wireless connection used for providing communication between the data source 14 and the database updating unit 13, the commercially available specific receivers as described herein, the receivers being integrated into the device 0, and corresponding specific transmitters integrated into the data source 14 or communicating therewith depending on the said type of the data sources 14 may be used. Additionally, the device 0 may use the same or different receivers such that to receive the entries based on at least one source accounting document 9 of the at least one external electronic apparatus having any type, to receive control data based on the remote user's request intended to generate any financial and/or management statements 10 and/or other information in any available form, to receive control data based on the another user's request intended to display the desired information on the display 13 of the device 0 or to receive updated data on the at least one of the natural accounting units from the external data source 14.

In order to provide the local user's request providing the generating in real-time scale any management and/or financial statements 10 by means of the first processor 3, the device 0 may further comprise standard input unit (not shown) integrated into the device 0 or external standard input unit (not shown) communicating with the device 0 by means of input/output port of the device 0, said port being configured to receive the external standard input unit (not shown). The standard input unit may be implemented in the form of common computer mouse or keyboard and etc.

The first processor 3 and/or the database handling unit 11, and/or the database updating unit 13 and/or the transmitter 15 of the device 0 may be implemented as corresponding parts of one program module and/or corresponding separated program modules, and/or as at least one hardware having at least one type described herein, and/or as a combination of the at least one program module and at least one hardware having the at least one type.

The database handling unit 11 may be embodied in various forms such as the first processor 3, an additional processor, a microcontroller designed to process data, an ASIC specialized for digital data processing or any other additional hardware which is integrated into the device 0.

When the first processor 3 and/or the database handling unit 11, and/or the database updating unit 13 are implemented as at least one program module and/or one program module, said means may be stored as corresponding database parts in one database or as corresponding separated databases. The one database and the separated databases may be stored into at least one data medium of any type described herein, wherein the at least one data medium may be the same or different with at least one of the data mediums comprising the first data storage 1 and second data storage 2 of the device 0. In addition, at least one of the first processor 3 and/or the database handling unit 11, and/or the database updating unit 13 of the device 0 may be stored together with the first data storage 1 and/or second data storage 2 of the device 0 in one database or in at least one database element of the one database.

In the present invention, in order to perform an electronic accounting upon entries based on at least one source accounting document 9 representing at least one business transaction of a businesses or individuals, a method implemented with a computer is used, the method comprising the steps of recording ledger accounts data into the first data storage 1 of the device 0 in natural accounting units using first data recording unit (not shown) connected with said first data storage 1, the ledger account data representing corresponding entries based on the at least one source accounting document 9 representing at least one business transaction and being updated in real time scale, wherein said ledger accounts are balanced; recording relative values of the accounting units into the second data storage 2 of the device 0 using second data recording unit (not shown), the relative values representing a correlation between at least two of the natural accounting units and being updated in real-time scale; and generating a management and/or financial statements 10 in at least one of the accounting units with its current relative value and/or in at least one natural accounting units on the basis of the ledger account data recorded in the first data storage 1 and on the basis of the relative values of accounting units, the relative values being recorded in the second data storage 2, using the first processor 3 connected with the first data storage 1 such that to obtain the ledger account data and with the second data storage 2 such that to obtain the relative values data.

Moreover, the above described method may be used in the device 0 for the purpose of the electronic accounting.

Furthermore, the step of recording the ledger account data may includes simultaneous recording said ledger account data into at least one basic storage element of the first data storage 1 of the device 0, said at least one basic storage element storing data of at least one basic ledger account, and into an additional storage element of the first data storage 1 of the device 0, said additional storage element storing data of the additional ledger account “Valuation adjustment” 8 used to cross-enter therethrough the ledger account data into the at least one basic ledger account in the natural accounting units.

The first and second data recording units (not shown) are configured to record the ledger accounts data into the first data storage 1 of the device 0 and to record the relative values of the accounting units into the second data storage 2 of the device 0, respectively. The device 0 may be provided by at least one data recording unit configured to record desired data both into the first and second data storages 1, 2. Anyway, at least one of the first and second data recording units may be implemented as optical discs recorder, HDD recorder, SSD recorder, flash memory recorder or any other recorder configured to record required data into at least one commercially available one data medium.

In addition, the generating step may include generating a management and/or financial statements 10 with the first processor 3 of the device 0 in response to user's local or remote request.

Additionally, the generating step may further include generating a statement of cash flows and/or a statement of financial position, and/or a statement of comprehensive income, and/or statement of changes in equity, and/or consolidated financial statements, and/or other financial and/or management statements.

Moreover, the method may comprise further step of updating the relative values of the accounting units stored in the second data storage 2 of the device 0 using the database updating unit 13 connected with an external data source 14 in a wire and/or wireless manner such that to obtain data on at least one of the natural accounting units. The external data source 14 may be implemented in the form of any commercially available database, server, website, satellite or other electronic devices.

Consistent with the present invention, in order to generate consolidated financial and/or management statements comprising consolidated data of corresponding at least two financial and/or management statements 10 generated for at least two businesses or individuals, a computer-implemented data processing system 100 may be used. As illustrated in FIG. 7, the data processing system 100 is configured to generate the consolidated financial and/or management statements upon entries based on at least one source accounting document 9 representing at least one business transaction of the at least two businesses or individuals. The data processing system 100 of FIG. 7 comprises computing unit 19 configured to form the consolidated financial and/or management statements; at least two devices 0 as described above, one for each business or individual of the at least two businesses or individuals, for generating in real-time scale a management and/or financial statements 10 of the each business or individual in at least one of the accounting units with its current relative value and/or in at least one of the natural accounting units. The data processing system 100 also comprises a third data storage 17 configured to store relative values of the accounting units, the relative values representing a correlation between at least two of the natural accounting units and being updated in real-time scale. Furthermore, the data processing system 100 comprises second processor 18 connected with the third data storage 17 such that to obtain the relative value data therefrom and with the first data storages 1 of the at least two devices 0 such that to obtain ledger account data therefrom, wherein the second processor 18 is configured to generate the consolidated management and/or financial statements based on the ledger account data stored in the first data storages of the at least two programmable devices in at least one of the accounting units with its current relative value and/or in at least one of the natural accounting units.

Furthermore, the data processing system 100 may further generate any of the financial and/or management statements corresponding to the at least two devices 0. In addition, the computing unit 19 may be the second processor 18.

Moreover, the data processing system 100 may use at least one of the second processor 18 and the first processor 3 of the at least two devices 0 such that to generate financial and/or management statements 10 corresponding to the at least two devices 0 and/or consolidated financial and/or management statements. Meanwhile, the first processor 3 of the at least two devices 0 and the second processor 18 may be implemented identically or differently from each other as defined above for the first processor 3. Furthermore, the data processing system 100 may use at least one of the third data storage 17 and the second data storages 2 of the at least two devices 0 such that to obtain the relative value data therefrom. Meanwhile, the third data storage 17 and the second data storages 2 of the at least two devices 0 may be implemented identically or differently from each other as defined above for the first data storage 1. Furthermore, the data processing system 100 may further comprise at least one data storage (not shown) configured to store ledger accounts containing further ledger account data representing corresponding entries based on the at least one further source accounting document representing at least one business transaction of other businesses or individuals and being recorded in said ledger accounts in natural accounting units in real-time scale, wherein said ledger accounts are balanced as well.

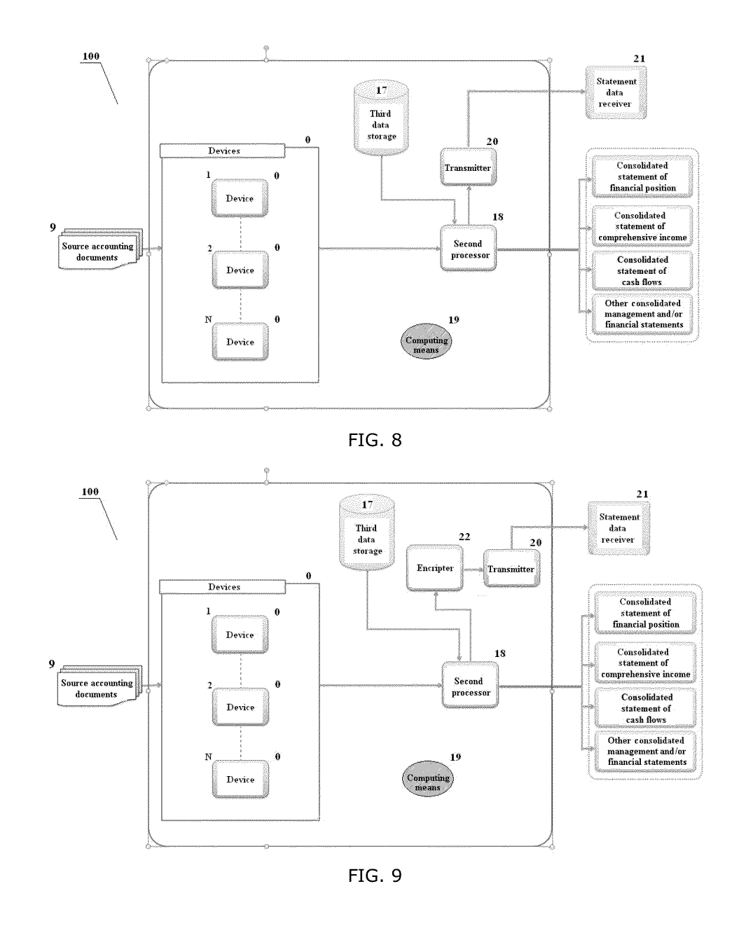

FIG. 8 shows one embodiment of the data processing system 100 of FIG. 7 further comprising a transmitter 20. Referring to FIG. 8, the transmitter 20 of the system 100 is connected with the second processor 18 such that to obtain the required data therefrom. The transmitter 20 is configured to transmit required data of the consolidated financial and/or management statements to a remote computer and/or server, and/or other electronic devices (said electronic devices are shown in FIG. 8 as statement data receiver 21 implemented as an external unit with respect to the system 100) in response to user's request and/or automatically, wherein the transmitter 20 is connected with said electronic devices such that to transmit the required data thereto.

FIG. 9 shows another embodiment of the data processing system 100 of FIG. 8 further comprising an encrypter 22. Referring to FIG. 9 the encrypter 22 is connected with the second processor 18 such that to obtain the required data to be encrypted. Thus, the encrypter 22 is configured to encrypt required data of the consolidated financial and/or management statements. In the illustrated embodiment, in addition to the connection with the second processor 18, the transmitter 20 is further connected with the encrypter 22 such that to obtain the encrypted required data to be transmitted. Thus, the transmitter 22 further configured to transmit the required data in the encrypted form.

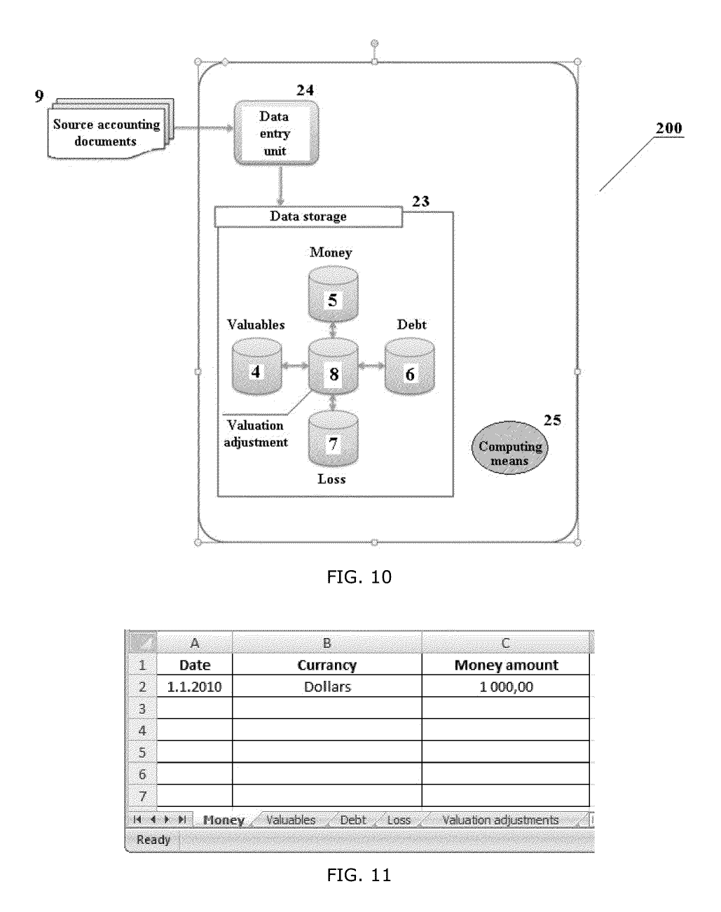

In the present invention, in order to fill a database comprising ledger accounts the filling device 200 may be used. The filling device as illustrated in FIG. 10 is configured to fill the database in electronic accounting in a cross-entry manner upon entries based on at least one source accounting document 9 representing at least one business transaction. Referring to FIG. 10 the filling device 200 comprises computing unit 25 configured to fill the database and a data storage 23 configured to store at least one basic ledger account of the database and one additional ledger account “Valuation adjustment” 8 of the database, wherein said at least one ledger account and said additional ledger account “Valuation adjustment” 8 contain ledger account data representing corresponding entries based on the at least one source accounting document 9 representing at least one business transaction and being recorded in the form of numerical values in natural accounting units with the positive and/or negative sign in real-time scale, and wherein sum of said ledger account data is equal to zero. Furthermore, the filling device 200 comprises a data entry unit 24 connected with the data storage 23 such that to cross-enter the ledger account data into said at least one basic ledger account of the database and said additional ledger account “Valuation adjustment” 8 of the database. Thus, the data entry unit 24 are configured to simultaneously enter four entries of ledger account data based on at least one source accounting document 9 representing at least one business transaction: enter a first entry of ledger account data representing corresponding entries based on the at least one source accounting document 9 representing at least one business transaction in the form of numerical values into a one basic ledger account of said at least one basic ledger account of the database in the natural accounting units with the positive sign; a second entry of the ledger account data in the form of numerical values into the additional ledger account “Valuation adjustment” 8 of the database in the natural accounting units of the first entry with the negative sign; a third entry of the ledger account data in the form of numerical values into another or the same basic ledger account of said at least one basic ledger account of the database in the natural accounting units with the negative sign, a fourth entry of the ledger account data in the form of numerical values into the additional ledger account “Valuation adjustment” 8 of the database in the natural accounting units of the third entry with the positive sign.

Additionally, in the illustrated embodiment the data storage 23 of the filling device 200 is further configured to store four basic ledger accounts: basic ledger account “Valuables” 4, basic ledger account “Money” 5, basic ledger account “Debt” 6, and basic ledger account “Loss” 7 of the database, and one additional ledger account “Valuation adjustment” 8 of the database, wherein said basic ledger accounts covering all data on financial position, economical activities and/or profits and losses of businesses or individuals and said configuration of the data storage 23 being optimal.

Furthermore, the filling device 200 or any embodiment of the filling device 200 as described above may be used in the device 0 of FIG. 2-6 or in any embodiment of the device 0, said embodiment being disclosed herein, in order to fill the first data storage 1 with the ledger account data. Besides, the system 100 may comprise at least one device 0 of the at least two devices 0 for electronic accounting used therein, the said at least one device 0 using any embodiment of the filling device 200 for filling the first data storage 1 of the device 0 with the ledger account data.

When the filling device 200 is used in the device 0 such that to fill the first data storage 1 of the device 0 and the device 0 is connected with the external electronic apparatus by means of a communication network according to the described above embodiment of the present invention, the data entry unit 24 is connected with the receiver of the device 0 such that to obtain the received ledger account data transferred via the communication network from the external electronic apparatus to the device 0. Additionally, the computer-implemented device 0 and the external electronic apparatus may form a computer-implemented system for electronic accounting.

In the present invention, in order to fill a database comprising ledger accounts in real-time scale in electronic accounting in a cross-entry manner upon entries based on at least one source accounting document representing at least one business transaction of a businesses or individuals, a filling method implemented with a computer is used, the filling method comprising the steps of entering a first entry of ledger account data representing corresponding entries based on the at least one source accounting document representing at least one business transaction in the form of numerical values into a first database element of the database, the first database element storing data of a one basic ledger account of said at least one basic ledger account of the database in natural accounting units with the positive sign using a data entry unit configured to simultaneously enter four entries of the ledger account data based on at least one source accounting document representing at least one business transaction; entering a second entry of the ledger account data in the form of numerical values into a second database element storing data of the additional ledger account “Valuation adjustment” 8 of the database in the natural accounting units of the first entry with the negative sign using the data entry unit configured to simultaneously enter four entries of ledger account data based on at least one source accounting document representing at least one business transaction; entering a third entry of the ledger account data in the form of numerical values into a third database element storing data of another or the same basic ledger account of the at least one basic ledger account of the database in natural accounting units with the negative sign using the data entry unit; entering a fourth entry of the ledger account data in the form of numerical values into the second database element of the database in the natural accounting units of the third entry with the positive sign using the data entry unit, wherein sum of the ledger account data entered into the first, second and third database elements is equal to zero.

Moreover, the above described filling method may be used in the filling device 200 or in any embodiment of the filling device 200 as described herein for the purpose of the filling the database comprising ledger accounts. Besides, the filling device 200 using the filling method may be used in the device 0 for filling the first data storage 1 of the device 0, said device 0 being particularly used in the system 100, as described above slightly in more detail.

In still another embodiment of the present invention, the device 0 may be further connected with an external computer or an external computing device in addition to the at least one source accounting document 9. The external computer or external computing device is configured to receive ledger account data from the at least one source accounting document 9. According to this embodiment, in case when the at least one source accounting document 9 is stored in electronic form in at least one external database, other external computer or external data server, the external computer or external computing device may be connected with the at least one external database, other external computer or data server such that to obtain ledger account data based on the at least one source accounting document 9 therefrom via a communication network such as LAN, Wi-Fi, 3G or 4G and etc. Such external computer or external computing device may comprise a data storage device for storing the received ledger account data. According to still another embodiment of the present invention, in case when the at least one source accounting document 9 is paper accounting document, the external computer or external computing device may comprise or be connected with a data input unit, such as keyboard, mouse and etc., configured to enter by a user the ledger account data corresponding to the at least one paper accounting document into the data storage device of the external computer or external computing device. Furthermore, according to one other embodiment, in case when the at least one source accounting document 9 is a paper accounting document, the external computer or external computing device may comprise or be connected with a scanning unit, such as a scanner, camera for capturing information of the at least one paper accounting document or other commercially available scanning device, configured to scan the at least one paper accounting document and recognize the scanned accounting documents such that to obtain desired ledger account data therefrom. Further, the external computer or external computing device may comprise a processor configured to identify the received ledger account data providing inclusion the identified data into at least one corresponding predetermined data group comprising data intended to be entered into a corresponding at least one basic storage element of the first data storage 1 therethrough the additional ledger account of the first data storage 1, wherein each of the data groups is stored in a corresponding storage element of the data storage device of the external computer or external computing device. The external computer or external computing device may further comprise a transmitter for transmitting data stored in the data storage device. Furthermore, the device 0 may be connected with the external computer or external computing device by means of a communication network, such as LAN, Wi-Fi, 3G or 4G and etc., comprising a data transfer unit for transferring the transmitted data from the external computer or external computing device to the device 0, wherein the transferred ledger account data may be received in the device 0 by means of the receiver of the device 0. The data transfer unit of the communication network may be a modem, router or other network device. The transmitter of the external computer or external computing device may be implemented in the form of hardware such as LAN transmitter, Bluetooth transmitter, Wi-Fi transmitter, IR-transmitter, WiMAX transmitter, 3G or 4G transmitter, or other commercially available transmitter integrated into the external electronic apparatus.

In still another embodiment of the present invention the first data storage 1 contains four basic storage elements, wherein a first basic storage element corresponds to a main ledger account “Valuables”, a second basic storage element corresponds to a main ledger account “Money”, a third basic storage element corresponds to a main ledger account “Debt”, and a fourth basic storage element corresponds to a main ledger account “Loss”, and the additional storage element of the first data storage corresponds to an additional ledger account “Valuation adjustment”. In this embodiment when the device 0 is connected with the above mentioned external computer or external computing device, the external computer or external computing device identifies the received ledger account data providing inclusion the identified data into at least one of four data groups: a first data group comprises data to be entered into a first basic storage element corresponding to the main ledger account “Valuables”, a second data group comprises data to be entered into a second basic storage element corresponding to the main ledger account “Money”, a third data group comprises data to be entered into a third basic storage element corresponding to the main ledger account “Debt”, and a fourth data group comprises data to be entered into a fourth basic storage element corresponding to the main ledger account “Loss”.

In addition, the at least basic ledger account stored in the first database element of the database may include four basic ledger accounts, such as basic ledger account “Valuables” 4, basic ledger account “Money” 5, basic ledger account “Debt” 6, and basic ledger account “Loss” 7, wherein each of said four basic ledger accounts comprises at least one basic ledger account “Valuables” table, at least one basic ledger account “Money” table, at least one basic ledger account “Debt” table and at least one basic ledger account “Loss” table, respectively. In particular, said basic ledger account tables comprise at least one row and at least one column.

An example of the above described filling method is as follows. For example, business owner has decided to invest 30000 rubles in the business as a start-up capital. However, the business owner transferred the desired money to an account of the business in U.S. dollars ($3000) on the basis of exchange rate which was current as at the date of the transferring operation. The transferring operation is recorded in the source accounting documents 9 of the business as an income with indication of contractor account and cash flow item, the item representing status of accrued debt as start-up capital. Entries of ledger account data based on the at least one source accounting document are entered into the basic ledger account “Money” 5, additional ledger account “Valuation adjustment” 8 and basic ledger account “Debt” 6 of the database. Meanwhile, entering is carried out four times. The first entry of the ledger account data is entered into the basic ledger account “Money” 5 of the database in natural accounting units corresponding to accounting units of the ledger account “Money” 5 with the positive sign, i.e. “+$1000”. Furthermore, the at least one basic ledger account “Money” table comprising, in particular, at least one row, the column “Date”, the column “Currency” and the column “Money amount” are filled with the ledger account data as appropriate in the process of entering the first entry (see FIG. 11).

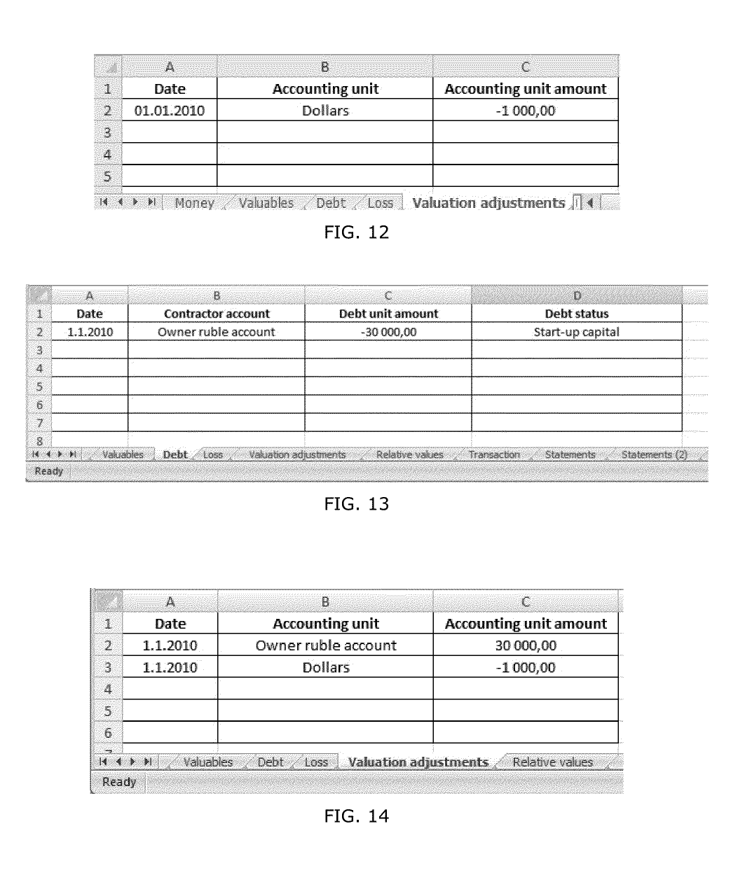

The second entry of the ledger account data is entered into the additional ledger account “Valuation adjustment” 8 of the database in natural accounting units of the first entry with the negative sign, i.e. “−$1000”. Furthermore, the at least one additional ledger account “Valuation adjustment” table comprising at least one row, the column “Date”, the column “Accounting unit”, the column “Accounting unit amount” are filled with the ledger account data as appropriate in the process of entering the second entry (see FIG. 12).

The third entry of the ledger account data is entered into the ledger account “Debt” 6 of the database in natural accounting units corresponding to accounting units of the ledger account “Debt” 6 with the negative sign, i.e. “−30 000” accounting units of the business owner debt according to a ruble account. Furthermore, the at least one ledger account “Debt” table comprising at least one row, the column “Date”, the column “Contractor account”, the column “Debt unit amount”, the column “Debt status” are filled with the ledger account data as appropriate in the process of entering the third entry (see FIG. 13).

The fourth entry of the ledger account data is entered into the ledger account “Valuation adjustment” 8 in natural accounting units corresponding to the third entry with the positive sign, i.e. “+30000” accounting units of the business owner debt according to a ruble account (see FIG. 14). In this case the additional ledger account “Valuation adjustment” table is filled with the ledger account data as appropriate for the second time in the process of entering the fourth entry.

Meanwhile, all of the first, second, third and fourth entries are entered at the same time. Likewise, further entries based on the source accounting documents 9 are recorded into the ledger accounts 4, 5, 6, 7, 8 of the data storage 23 in a similar manner, wherein the first and third entries may be entered into the same basic ledger account or into different basic ledger accounts, while the second and fourth entries are always entered into the additional ledger account “Valuation adjustment” 8.

Sum of ledger account data as recorded both in the basic ledger accounts and additional ledger account “Valuation adjustment” 8, in particular sum of the data as recorded in the column “Accounting unit amount” of the basic ledger account tables and additional ledger account table, is equal to zero. It means that sum of all positive values is equal to sum of all negative values, that corresponds to the double-entry principle when the debit amount is equal to the credit amount (ledger accounts are balanced). However, recording and accounting of data are carried out in natural accounting units.

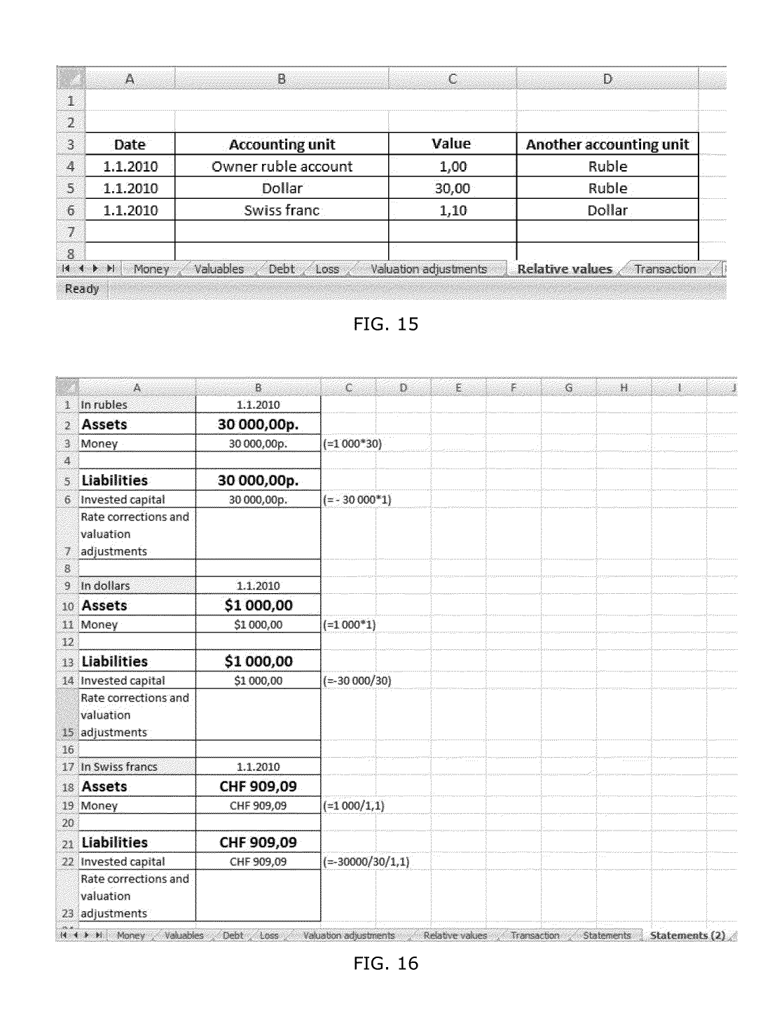

In one embodiment of the present invention the device 0 may comprise the first data storage 1 configured to store at least one basic ledger accounts and additional ledger account “Valuation adjustment” 8, the first data storage 1 being filled with the filling device 200. Thus, while filling the first data storage 1 by means of the filling device 200 in real-time scale the first processor 3 of the device 0 first may use the ledger account data entered into the corresponding ledger accounts of the first data storage 1 in corresponding natural accounting units and use the relative values of the accounting units stored in the second data storage 2 of the device 0 at any time of the filling process. Furthermore, the second data storage 2 of the device 0 may be configured to store the relative values of the accounting units in at least one relative values table comprising at least one row and at least one column forming at least one table cell for recording the relative values of the accounting units thereinto. In one embodiment, for example, the second data storage 2 of the device 0 may comprise at least one row and at least four columns, such as the column “Date”, the column “Accounting unit”, the column “Value” and the column “Another accounting unit”, wherein the column “Accounting unit” and the column “Another accounting unit” represent at least two correlated accounting units. Explanatory view of the at least one relative values table of the second data storage 2 of the device 0 is shown in FIG. 15.

As a result, the first processor 3 of the device 0 may generate desired financial and/or management statements 10, e.g. statement of cash flows and/or a statement of financial position, and/or a statement of comprehensive income, and/or any other financial and/or management statements 10, by exchanging the ledger account values stored in the at least one ledger account of the first data storage 1 into any common currency or another accounting unit. A part of the one explanatory statement of financial position generated by the first processor 3 of the device 0 is illustrated in FIG. 16.

The “Money” item of the statement as illustrated in FIG. 16 is obtained by means of exchanging the “+$1000” (see explanatory basic ledger account “Money” table as shown in FIG. 11) into a statement currency based on data stored in the second data storage 2 as shown in FIG. 15. The “Invested capital” item of the statement of FIG. 16 is obtained by exchanging the “−30000 debt units” (see explanatory basic ledger account “Debt” table as shown in FIG. 16) into the statement currency based on data stored in the second data storage 2 of the device 0.

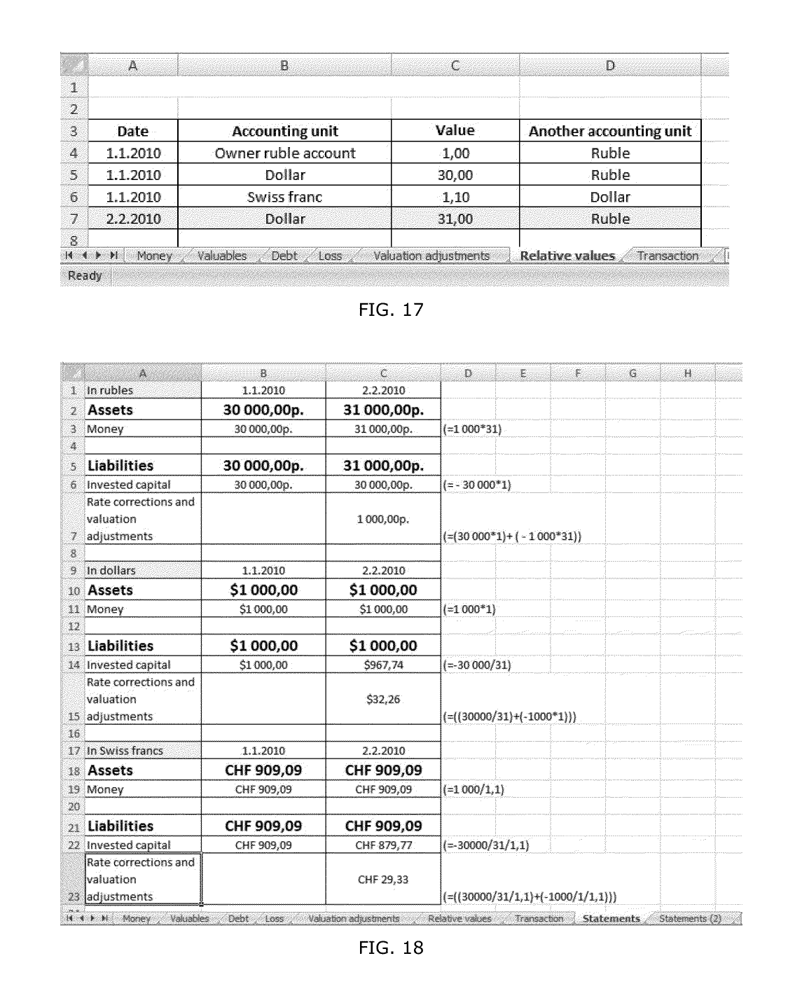

When relative value of at least one accounting unit is changed in a time, the corresponding record is entered into the relative values table of the second data storage 2 of the device 0 for a data corresponding to the changing (see FIG. 17).

As a result, the statement part shown in FIG. 16 is changed as illustrated in FIG. 18.

The item “Rate corrections and valuation adjustments” of the statement as illustrated in FIG. 18 is obtained by exchanging the “+30000 debt units” of the business owner ruble account and the “−$1000” stored in the additional ledger account “Valuation adjustment” table (see FIG. 14) into the corresponding statement currency based on data stored in the relative values table of the second data storage 2 (see FIG. 17).

The illustrated parts (see FIG. 16 and FIG. 18) represent the statement of financial position in rubles, U.S. dollars or Swiss francs, and they may be generated in any another currency or accounting unit at any time during activity of businesses or individuals. In particular the assets of the statement of FIG. 18 are equal to liabilities of said statement providing the balance of the ledger accounts stored in the first data storage 1 of the device 0 after exchanging all natural accounting units into the common statement currency.

Moreover, the above-noted features and other aspects and principles of the present invention may be implemented in various environments.

Such environments and related applications may be specially constructed for performing the various processes and operations of the invention or they may include a general purpose computer or computing platform selectively activated or reconfigured by code to provide the necessary functionality. The processes disclosed herein are not inherently related to any particular computer or other apparatus, and may be implemented by a suitable combination of hardware, software, and/or firmware. For example, various general purpose machines may be used with programs written in accordance with teachings of the invention, or it may be more convenient to construct a specialized apparatus or system to perform the required methods and techniques.

Devices, systems and methods consistent with the present invention also may include computer readable media that include program instruction or code for performing various computer-implemented operations based on the methods and processes of the invention. The media and program instructions may be those specially designed and constructed for the purposes of the invention, or they may be of the kind well-known and available to those having skill in the computer software arts. Examples of program instructions include for example machine code, such as produced by a compiler, and files containing a high level code that can be executed by the computer using an interpreter.

Thus, certain devices and/or systems and/or methods consistent with the present invention may include a computer program product having a computer-readable code which, when run on a computer, causes the computer to enter electronic accounting upon entries based on at least one source accounting document 9 representing at least one business transaction, comprising the following computer-readable code for effecting actions in the computer: code for recording ledger accounts data into the first data storage 1 of the device 0 in natural accounting units using first data recording unit (not shown) integrated into the device 0 and connected with the first data storage 1, the ledger account data representing corresponding entries based on the at least one source accounting document 9 representing at least one business transaction and being updated in real time scale, wherein said ledger accounts are balanced; code for recording relative values of the accounting units into the second data storage 2 of the device 0 using second data recording unit (not shown) integrated into the device 0, the relative values representing a correlation between at least two of the natural accounting units and being updated in real-time scale; and code for generating a management and/or financial statements 10 in at least one of the accounting units with its current relative value and/or in natural accounting units on the basis of the recorded ledger account data and the recorded relative values of accounting units using the first processor 3 connected with the first data storage 1 such that to obtain the ledger account data and with the second data storage 2 such that to obtain the relative values data.

Furthermore, the computer program product may further comprise code for updating the relative values of the accounting units stored in the second data storage 2 of the device 0 using database updating unit 13 connected with the external data source 14 in a wire and/or wireless manner such that to obtain data on at least one of the natural accounting units.

Moreover, certain devices and/or systems and/or methods consistent with the present invention may include another computer program product having a computer-readable code which, when run on a computer, causes the computer to enter electronic filling a database comprising ledger accounts in electronic accounting in a cross-entry manner upon entries based on at least one source accounting document 9 representing at least one business transaction, comprising the following computer-readable code for effecting actions in the computer: code for entering a first entry of ledger account data representing corresponding entries based on the at least one source accounting document 9 representing at least one business transaction in the form of numerical values into a first storage element storing data of a one basic ledger account of at least one basic ledger account of the database in natural accounting units with the positive sign using a data entry unit configured to simultaneously enter four entries of the ledger account data based on at least one source accounting document 9 representing at least one business transaction; code for entering a second entry of the ledger account data in the form of numerical values into a second database element storing data of the additional ledger account “Valuation adjustment” 8 of the database in the natural accounting units of the first entry with the negative sign using the data entry unit; code for entering a third entry of the ledger account data in the form of numerical values into a third database element storing data of another or the same basic ledger account of the at least one basic ledger account of the database in natural accounting units with the negative sign using the data entry unit; code for entering a fourth entry of the ledger account data in the form of numerical values into the second database element in the natural accounting units of the third entry with the positive sign using the data entry unit, wherein sum of ledger account data entered into the first, second and third database elements is equal to zero.

A number of exemplary embodiments have been described above. Nevertheless, it will be understood that various modifications may be made. For example, suitable results may be achieved if the described components in a described system, methods and/or devices are combined in a different manner and/or replaced or supplemented by other components or their equivalents. Accordingly, other implementations are within the scope of the following claims.

1. A computer-implemented system for electronic accounting, comprising:
an external electronic apparatus (9) comprising
a data storage device for storing ledger account data, and
a transmitter for transmitting the ledger account data;
a computer-implemented device (0) for the electronic accounting, comprising:
a receiver for receiving the transmitted ledger account data;
a first processor (3) configured to perform the electronic accounting;
a first data storage (1) containing at least one basic storage element of the first data storage for storing data of main ledger accounts, and an additional storage element of the first data storage for storing data of an additional ledger account;
a data entry unit (24) connected to the receiver and to the first data storage and configured to simultaneously enter four entries of the ledger account data in a cross-entry manner, such that
first data are entered into one basic storage element of the first data storage, wherein the first data are based on the received ledger account data,
second data are entered into the additional storage element of the first data storage for balancing the entered first data,
third data are entered into one basic storage element of the first data storage, wherein the third data are based on the received ledger account data,
forth data are entered into the additional storage element of the first data storage for balancing the entered third data;
a second data storage (2) for storing relative values of accounting units for the data of main ledger accounts, the relative values representing a correlation between at least two of the accounting units; wherein
the first processor (3) is further configured to automatically generate management and/or financial statements and is connected with the first data storage (1) to obtain the data of main ledger accounts and with the second data storage (2) to obtain the relative values, the first processor (3) further converting the data of main ledger accounts into data subject to inclusion to the management and/or financial statements on the basis of the obtained relative values.

2. The system of claim 1, wherein said first processor (3) is configured to generate a management and/or financial statements in response to user's local or remote request.

3. The system of claim 1, wherein said first processor (3) is configured to generate a statement of cash flows and/or a statement of financial position, and/or a statement of comprehensive income, and/or statement of changes in equity, and/or consolidated financial statements, and/or other financial and/or management statements.

4. The system of claim 3, further comprising data updating unit configured to update in a real-time scale the relative values stored in the second data storage, wherein said data updating unit are connected with a data source in a wire and/or wireless manner to obtain data such that to update the relative values stored therein.

5. The system of claim 4, wherein the data source connected with the data updating unit is a database, server, website, satellite or another electronic device.

6. The system of claim 1, further comprising a transmitter configured to transmit data on the management and/or financial statements in a wire and/or wireless manner to a remote computer and/or server, and/or other electronic devices in response to user's request and/or automatically, said transmitter being connected with the first processor (3) such that to obtain data therefrom and with said remote computer and/or server, and/or other electronic devices in the wire and/or wireless manner such that to transmit the obtained data thereto.

7. The system of claim 1, wherein both the data recorded in the at least one basic storage element of the first data storage and the data recorded in the additional storage element of the first data storage are updated in a real time scale.

8. The system of claim 1, wherein the first data storage contains four basic storage elements, wherein a first basic storage element corresponds to a main ledger account “Valuables”, a second basic storage element corresponds to a main ledger account “Money”, a third basic storage element corresponds to a main ledger account “Debt”, and a forth basic storage element corresponds to a main ledger account “Loss”, and the additional storage element of the first data storage corresponds to an additional ledger account “Valuation adjustment”.

9. A computer-implemented method of electronic accounting, the computer-implemented method comprising the steps of:
receiving, by a receiver, ledger account data from an external electronic apparatus, wherein the ledger account data represent entries based on at least one accounting document for the electronic accounting;
entering first data into one basic storage element of at least one basic storage element of a first data storage using a data entry unit, wherein the first data are based on the received ledger account data;
entering second data into an additional storage element of the first data storage using the data entry unit to balance the entered first data;
entering third data into one basic storage element of the at least one basic storage element of the first data storage using the data entry unit, wherein the third data are based on the received ledger account data;
entering forth data into the additional storage element of the first data storage using the data entry unit to balance the entered third data;
entering relative values of the accounting units for the data of main ledger accounts into a second data storage using the data entry unit, the relative values representing a correlation between at least two of the accounting units;
transmitting the data of main ledger accounts from the first data storage to a first processor (3) connected with the first data storage;
transmitting the relative values from the second data storage to the first processor (3) connected with the second data storage;
converting the obtained data of main ledger accounts into data subject to inclusion to the management and/or financial statements on the basis of the obtained relative values using the first processor (3); and
generating a management and/or financial statements in at least one of the accounting units on the basis of the converted data using the first processor (3).

10. The method of claim 9, wherein the step of generating includes generating a management and/or financial statements in response to user's local or remote request.

11. The method of claim 9, wherein the step of generating includes generating a statement of cash flows and/or a statement of financial position, and/or a statement of comprehensive income, and/or statement of changes in equity, and/or consolidated financial statements, and/or other financial and/or management statements.

12. The method of claim 9, further comprising updating the relative values stored in the second data storage in a real-time scale on the basis of data from a data source using a data updating unit connected with the data source in a wire and/or wireless manner.

13. The method of claim 12, wherein the data source is a database, server, website, satellite or another electronic device.

14. The method of claim 9, further comprising updating both the data recorded in the at least one basic storage element of the first data storage and the data recorded in the additional storage element of the first data storage in a real time scale.

15. A computer-implemented data processing system (100) for generating a consolidated financial and/or management statements, the data processing system comprising:
a second processor (18) configured to form the consolidated financial and/or management statements;
at least two computer-implemented systems (0) of claim 1, one for each business or individual, for generating a financial and/or management statements of the each business or individual;
a third data storage (17) for storing relative values of accounting units for data of main ledger accounts, the relative values representing a correlation between at least two of the accounting units; wherein
the second processor (18) is further configured to generate a consolidated financial and/or management statements and is connected with the first data storages (1) of the at least two computer-implemented systems (0) such that to obtain the data of main ledger accounts therefrom and connected with the third data storage (17) such that to obtain the relative values therefrom, the second processor (18) further converting the obtained data of main ledger accounts into data subject to inclusion to the consolidated management and/or financial statements on the basis of the obtained relative values.

16. The system of claim 15, further comprising a transmitter configured to transmit data of the consolidated financial and/or management statements to a remote computer and/or server, and/or other electronic devices in response to a user's request and/or automatically, said transmitter being connected with the second processor (18) such that to obtain data therefrom and connected with said electronic devices such that to transmit data thereto.

17. The system of claim 16, further comprising an encrypter configured to encrypt data of the consolidated financial and/or management statements, wherein said transmitter is connected with the second processor (18) such that to obtain data to be encrypted and connected with the encrypter such that to obtain the encrypted data to be transmitted, said transmitter being further configured to transmit the obtained encrypted data in an encrypted form.

18. The system of claim 15, wherein the relative values stored in the third data storage are updated in real-time scale.
